(19) United States
(12) Patent Application Publication
(10) Pub. No.: US 2026/0340758 A1
(43) Pub. Date: Oct. 29, 2026

(54) METHOD FOR EMPLOYING SOURCE ROUTING WITH DETERMINISTIC PATHS FOR AI WORKLOADS

(71) Applicant: Dell Products L.P., Round Rock, TX (US)

(72) Inventors: Venkatesan Mahalingam, Pleasanton, CA (US); Senthil Kumar Ganesan, San Ramon, CA (US); Udhayachandran Shanmugam, Santa Clara, CA (US); Vinoth Kumar Arumugam, Fremont, CA (US)

(21) Appl. No.: 19/186,740

(22) Filed: Apr. 23, 2025

(51) Int. Cl. G06T 1/20

(52) U.S. Cl. CPC G06T 1/20

(57) ABSTRACT

In general, certain embodiments described herein relate to a method for managing data transfer workloads. The method includes distributing a first portion of a workload across a plurality of sessions. Next, the method includes making a first determination that a path within the plurality of sessions is experiencing congestion. Then, the method includes redistributing, after the determination, a second portion of the workload to optimize the data transfer speed. The method then makes a second determination that the workload is not fully transferred. Following this determination, the method makes a third determination that a second path within the plurality of sessions is experiencing congestion. Accordingly, the method then redistributes, after the third determination, a third portion of the workload to the plurality of sessions.

### BACKGROUND

In high-density server environments, optimizing data transfer between servers can result in significant improvements within the overall environment. Efficiency is often improved by load balancing data transfer to reduce congestion in a network. However, efficiently load balancing remains a complex task due to lagging congestion information and network complexity within the server environment.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a system in accordance with one or more embodiments of the disclosure.

FIG. 1.2 shows a diagram of a server in accordance with one or more embodiments of the disclosure.

FIG. 1.3 shows a diagram of a network interface card (NIC) in accordance with one or more embodiments of the disclosure.

FIG. 2.1 shows a flowchart of a method for assigning paths to sessions in accordance with one or more embodiments of the disclosure.

FIG. 2.2 shows a flowchart of a method for assigning session headers to paths in accordance with one or more embodiments of the disclosure.

FIG. 2.3 shows a flowchart of a method for transferring a workload between servers in accordance with one or more embodiments of the disclosure.

FIG. 2.4 shows a flowchart of a method for notifying a source server about congestion along a path in accordance with one or more embodiments of the disclosure.

FIG. 3 shows an example network fabric in accordance with one or more embodiments of the disclosure.

FIG. 4 shows a diagram of a computing device in accordance with one or more embodiments of the disclosure.

### DETAILED DESCRIPTION

In modern server environments, efficiently transferring data between servers poses a significant challenge. Inefficiencies in each data transfer can bottleneck the entire network fabric and delay task completion across the entire server environment. Traditional data transfer management methodologies struggle to quickly respond to changes within the network fabric due to a delay in real-time network congestion information. This lack of real-time information leads to inefficient or static load balancing.

Further, as network fabrics become more complex due to the addition of layers within the network fabric, the traditional approach includes additional inefficiency as the approach cannot effectively identify which segment within the network fabric is experiencing the congestion. This further compound the problem as the lack of granular detail coupled with the delay in real-time congestion information leads to inefficient and reactive load balancing. Based on the above, there is a need in the industry to provide more efficient data management solutions.

In light of the above issues within the traditional approaches, this disclosure provides a system for managing data transfer workloads using switches within the network fabric to provide more accurate and granular information relating to congestion information. In doing so, the solution optimizes load balancing for large data transfer between servers. The system operates by calculating all paths within target GPU pairs (e.g., a source GPU and a destination GPU), assigning session headers to sessions associated with each path, continuously receiving congestion information from switches which transmit the congestion information by reversing the session headers associated with the paths the data transfers on, and continuously load balancing portions of the workload using the updated congestion information to avoid specifying segments in the network fabric.

Specific embodiments will now be described with reference to the accompanying figures.

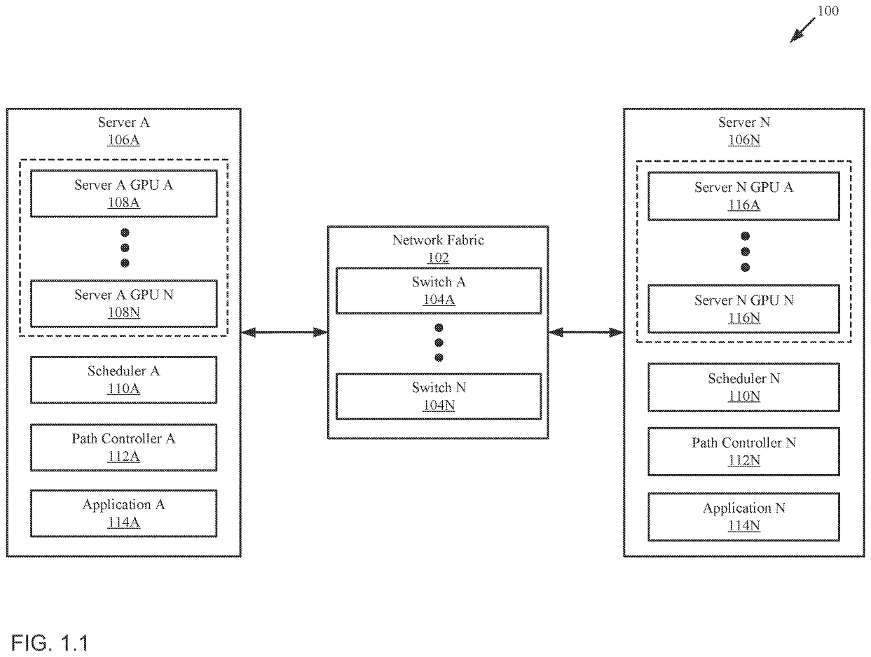

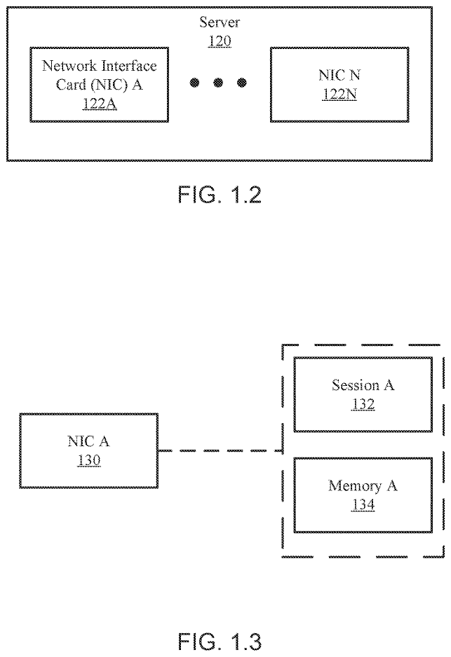

FIG. 1.1 shows a system in accordance with one or more embodiments of the disclosure. They system may include a network fabric (102) and a plurality of servers (e.g., Server A (106A), Server N (106N)). The system may include additional, fewer, and/or different components without departing from the scope of the disclosure. For example, in one or more embodiments, the system includes only one server (e.g., Server A (106A)). Each component may be operably/operatively connected to any of the other components via any combination of wired and/or wireless connections. Each component illustrated in FIG. 1.1 is discussed below.

In one or more embodiments, the multiple servers (e.g., Server A (106A), Server N (106N)) may be operatively connected to one another through the network fabric (102) (e.g., a local area network (LAN), a wide area network (WAN) such as the Internet, a mobile network, any other network type, or a combination thereof). Further, the network fabric (102) may encompass various interconnected, network-enabled subcomponents (or systems) (e.g., switch A (104A), switch N (104N)) that may facilitate communications between the aforementioned components. Moreover, the multiple servers (e.g., Server A (106A), Server N (106N)) may communicate with one another using any combination of wired and/or wireless communication protocols.

In one or more embodiments, the network fabric may include the functionality to facilitate bi-directional data transfer between connected components (e.g., Server A (106A), Server N (106N)). As used herein, bi-directional travel is defined as data traveling in both directions between connected servers. Said another way, a server (e.g., Server A (106A)) may both transmit and receive data from the same pathway facilitated by the network fabric (102). The network fabric (102) may also include the functionality to identify network congestion via the switches. In one or more embodiments, the network fabric (102) also includes functionality to identify data source ports and instruct the data source ports to reduce data transmission. Further, in one or more embodiments, the network fabric (102) may consist of multiple segments where each connection between two switches in the network fabric is a segment. As a non-limiting example, data traveling between switch A and switch N would travel across segment A-N.

Turning to the switches (e.g., Switch A (104A), Switch N (104N)) in the network fabric (102), in one or more embodiments, the switches may be a physical hardware device such as a network switch configured to facilitate connection between multiple devices such as computing devices, servers, server racks, etc. The switches may operate on multiple levels within the network fabric (102) that, together, form the network fabric topology. As a non-limiting example, certain switches may operate at a lower level that directly connects to the device layer (e.g., Server A (106A), Server N (106N)). Another set of switches may operate at a higher level and only connect to the switches that connect to the device layer. In this manner, the switches form a two-tiered topology. More layers may be formed by more switches without departing from the scope of the disclosure. Said connection between switch layers may be implemented over one or more networks (e.g., local area networks (LANs), wide area networks (WANs) such as the Internet, mobile networks, etc.). Other connection methods may be used without departing from the scope of the disclosure.

In one or more embodiments, the switches (e.g., Switch A (104A), Switch N (104N)) may include the functionality to receive and transmit data from the connected devices (e.g., Server A (106A), Server N (106N)) and other switches. In one or more embodiments, the switches (e.g., Switch A (104A), Switch N (104N)) may also include the functionality to identify data congestion and send a payload back to the source device with instructions to reduce the data transmission via said switch. Said another way, the switches may include the functionality to instruct connected devices to direct traffic through alternate pathways. The switches may also include the functionality to identify session headers within transmitted data packets and alter the session headers to send to the next switch or connected device. More broadly, the switch includes the functionality to read and modify session headers associated with the data source.

Turning to the server (e.g., Server A (106A)), in one or more embodiments the server may be a computing device that contains multiple components including graphics processing units (GPUs), storage devices (e.g., Solid State Devices (SSDs), etc.) network interface cards (NIC) (e.g., NIC A), scheduling modules (e.g., Scheduler A (110A)), controllers (e.g., Path Controller A (112A)) and applications (e.g., Application A (114A)). The server (e.g., Server A (106A) may include more components without departing from the scope of the disclosure.

In one or more embodiments, the server (e.g., Server A (106A)) may include the functionality to transmit data, connect to external devices, complete assigned tasks, and store data. The server may include additional functionality without departing from the scope of the disclosure. Further, while one server (e.g., Server A (106A)) is discussed here, the system may include multiple servers (e.g., Server A (106A), Server N (106N)) where each server includes different components. The various components within the server are discussed below.

Turning to the server GPU (server A GPU A (108A)), the server GPU includes the functionality to process computationally intensive tasks such as artificial intelligence or machine learning training, simulations, three dimensional rendering, etc. The server GPU may include additional functionality without departing from the scope of the disclosure. In one or more embodiments, the server GPU may include any number of GPU ports which include the functionality to transmit data based on instructions from the scheduler. Further, in one or more embodiments, each server GPU may be associated with a network interface card (NIC) (further described in FIG. 1.2) such that each GPU has a one-to-one mapping of GPU to NIC. In this manner, every port associated with one GPU is connected to the same NIC. In one or more embodiments, the server GPU includes the functionality to transmit and receive data from a NIC. The server GPU may also independently transmit and receive data without departing from the scope of the disclosure herein.

Turning to the scheduler (e.g., Scheduler A (110A)), in one or more embodiments the scheduler may be a physical component within the server dedicated to managing and scheduling data flow from one server to another component. In other embodiments, the scheduler may be a software component programmed to manage data flow to and from the server. The scheduler may include the functionality to receive data from switches, modify data traffic loads between pathways, and transmit data to connected devices.

Turing to the path controller (e.g., Path Controller A (112A)), in one or more embodiments, the path controller may be a physical component within the server dedicated to calculating all possible pathways between a source server (e.g., Server A (106A)) and a destination server (e.g., Server N (106N)). In one or more embodiments, the path controller may be a software component programmed to calculate the pathways. Alternatively, in yet another embodiment, the path controller may be an edge device located outside of the server and dedicated to calculating the pathways for data to travel between the servers or connected devices.

In one or more embodiments, the path controller (e.g., Path Controller A (112A)) may include the functionality to calculate all pathways between GPUs in different servers (e.g., GPU 1 in Server A to GPU 1 in Server N), initiate multiple sessions based on the number of calculated pathways, and build session headers for each session. In one or more embodiments, the session headers include segment information related to the segments in the network fabric (102) that the data will travel along. In one or more embodiments, the session headers may include a source header and a destination header. In one or more embodiments, the source header may be associated with the source of the data i.e., the entity transmitting the information. In one or more embodiments, the destination header may be associated with the entity receiving the data such as a destination GPU. As a non-limiting example, the path controller may build a segment routing header (SRv6) into a ROCEv2 header and assign the header to a session. Further, in one or more embodiments, the SRv6 header may comprise a user datagram protocol (UDP) header which includes a sequentially ordered segment list for the path associated with the header. Any method of developing and assigning headers may be used without departing from the scope of the disclosure.

Turning to the application (e.g., Application A (114A)), the application may be a software program running on the server which requires some data transfer or communication with another server. In one or more embodiments, the application (e.g., Application A (114A)) may connect to an application on another server (e.g., Application N (114N)) to complete a task. In another embodiment, the applications together may be used to complete tasks. While the system (100) shows two applications, more applications can be deployed without departing from the scope of the disclosure. In one or more embodiments, each server (e.g., Server A (106A), Server N (106N)) may include multiple applications and may include different numbers of applications.

Turning to FIG. 1.2, FIG. 1.2 shows a diagram of a server in accordance with one or more embodiments of the disclosure. The server (120), which may be the same as the server (106A) of FIG. 1.1, may include one or more network interface cards (NIC) (e.g., NIC A (122A), NIC N (122N)). The server (120) may include additional, fewer, and/or different components without departing from the scope of the disclosure. Each component may be operably/operatively connected to any of the other components via any combination of wired and/or wireless connections. Each of these components is described below.

Turning to the NIC (e.g., NIC A (122A), NIC N (122N)), in one or more embodiments, the NIC may be a physical hardware device (e.g., network adapter, LAN card, ethernet card, etc.) configured to enable communication and data transfer between devices over a network. In one or more embodiments, the NIC may communicate with GPU ports, switches in the network fabric (e.g., Switch A (104A), Switch N (104N)), and other server components. The NIC can communicate with any server component without departing from the scope of this disclosure.

In one or more embodiments, the NIC (e.g., NIC A (122A), NIC N (122N)) may include the functionality to receive instructions from the scheduler, transmit data from one server to another connected component, communicate with multiple GPU ports across multiple GPUs in a server, and identify queue draining rates associated with paths in the network fabric. The NIC may include additional functionality without departing from the disclosure. In one or more embodiments, each GPU within a server is associated with an individual NIC. As a non-limiting example, if there are 8 GPUs in a server, there will be 8 NICs in the server. While the example depicts unique GPU and NIC pairings, in one or more embodiments, a NIC can be associated with more than one GPU without departing from the scope of the disclosure. However, it should be noted that unique NIC to GPU pairings results in optimal data transfer speeds.

Turning to FIG. 1.3, FIG. 1.3 shows a diagram of a network interface card (NIC) in accordance with one or more embodiments of the disclosure. The NIC A (130), which may be the same as the NIC A (122A) in FIG. 1.2, may include a session A (132) and a memory A (134). In one or more embodiments, each NIC in the system may be associated with a session and a memory. Each of these components is described below.

In one or more embodiments, the session (e.g., Session A (132)) is a software component configured to send data through an associated path. In one or more embodiments, each session may be associated with a unique path within the network fabric. Further, in one or more embodiments, the sessions may be initialized by a path controller where each session corresponds to a unique path from one server to another server through the network fabric. In one or more embodiments, other components, such as the NIC, may be used to initialize sessions.

In one or more embodiments, the session (e.g., Session A (132)) may include the functionality to contain path information, via session headers, and transmit data through the session. In one or more embodiments, the session may include the functionality to create a connection between two servers, or more generally two components, to facilitate the data transfer. As a non-limiting example, a session may allow two servers to transmit data via path 1.

Turning to the memory (e.g., Memory A (134)), in one or more embodiments, the memory may be a segment in a physical storage device associated with a session. Each session may be associated with a unique memory. As a non-limiting example, if there are 20 sessions, there may be 20 memories with each memory associated with a unique session. Further, in one or more embodiments, the memory may be connected to the session via any connection medium (e.g., wired connection, LAN, ethernet, other wireless connections, etc.). In yet another embodiment, the memory may be located in an edge device separate from the server or in cloud data storage. Any memory type and location may be used without departing from the scope of this disclosure.

In one or more embodiments, the memory (e.g., Memory A (134)) may include the functionality to store the data which will be transferred to other components (e.g., data transfer from server A to server N). The memory may include the functionality, in one or more embodiments, to connect with other components in the server (e.g., path controller, scheduler, NIC, etc.) to store the data. Further, the memory (e.g., Memory A (134)) may include the functionality to identify queue draining rates associated with the data transfer rates of the workload. The memory (e.g., Memory A (134)) may include additional functionality without departing from the scope of the disclosure.

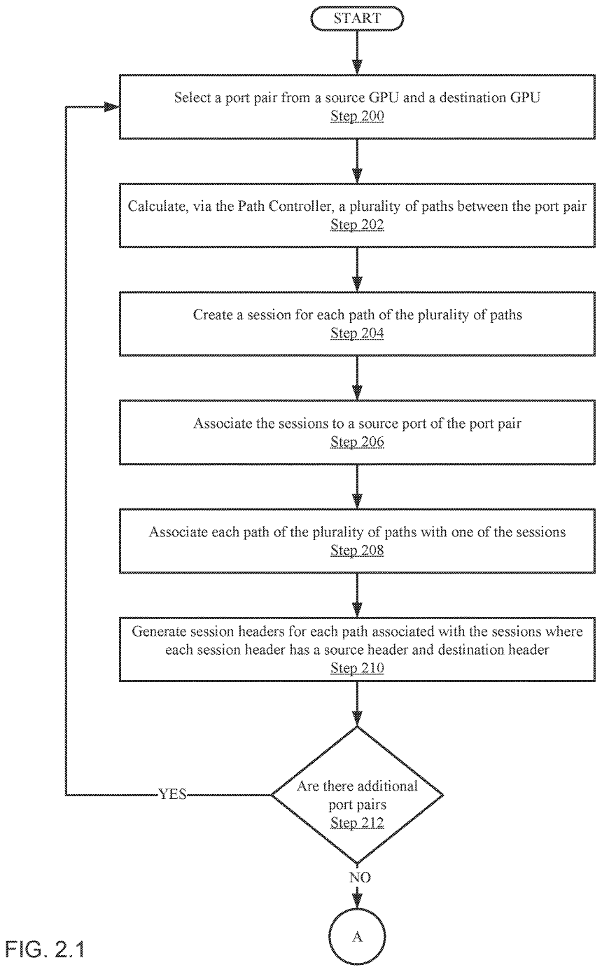

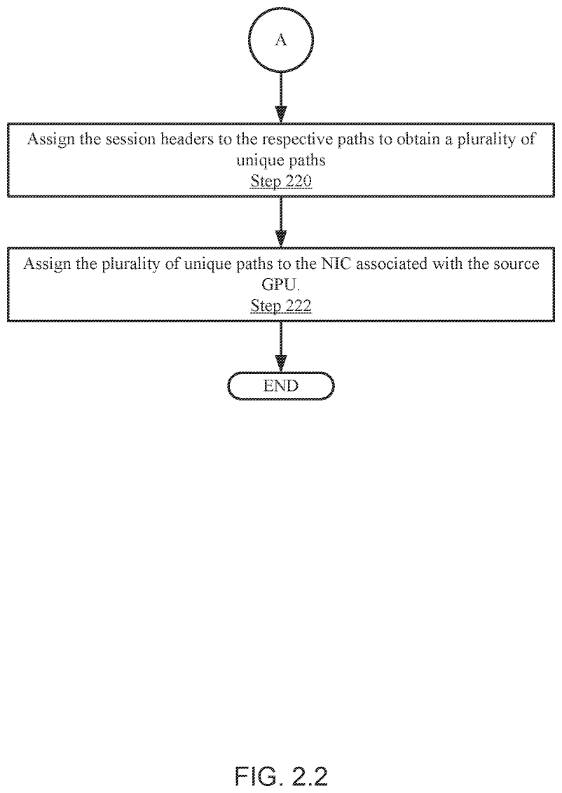

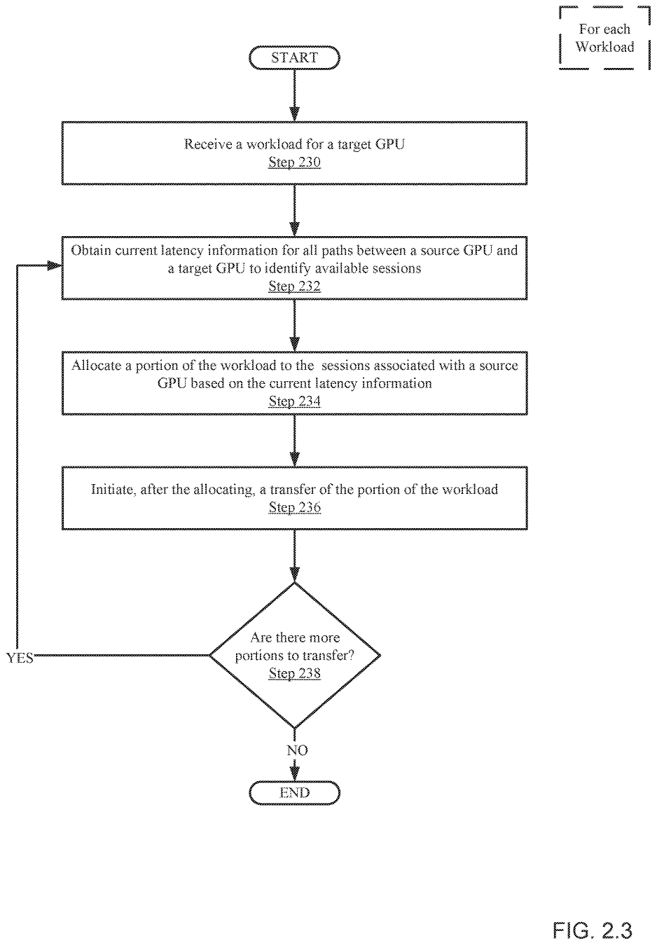

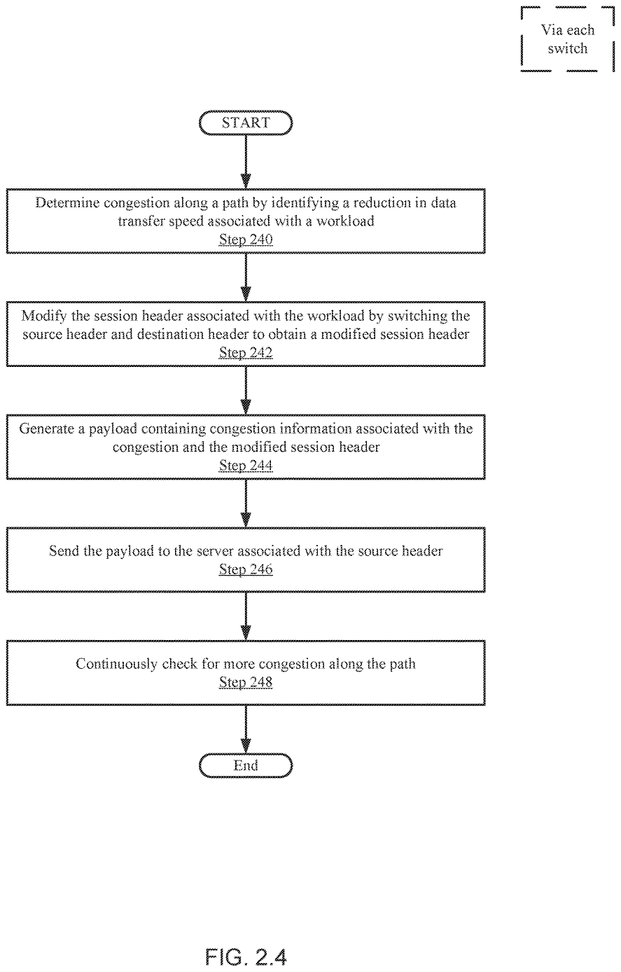

Turning to FIG. 2.1, FIG. 2.1 shows a flowchart of a method for assigning paths to sessions in accordance with one or more embodiments of the disclosure. The method may be performed by, for example, the path controller (FIG. 1.1, 112A). Other components in the system may perform this method without departing form the scope of this disclosure.

While the various steps in the flowchart shown in FIG. 2.1 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2.1 may be performed concurrently with one or more steps in FIG. 2.2 and FIG. 2.3.

In step 200, the path controller (e.g., FIG. 1.1, 112A) selects a port pair from a source GPU and a destination GPU. In one or more embodiments, the port pair consists of one GPU port from the source GPU and one GPU port from the destination GPU. As a non-limiting example, the port pair may be GPU port 1 in the source GPU and GPU port 8 in the destination GPU. Further, the source GPU and the destination GPU may be in different servers such that they are connected via a network fabric (e.g., FIG. 1.1, 102). Any port pair may be selected without departing from the scope of this disclosure.

In step 202, the path controller calculates every possible path data can be transferred across between the port pair. In one or more embodiments, the paths are determined by the number and layers of switches in the network fabric (e.g., FIG. 1.1, Switch A (104A), Switch N (104N)). The more layers of switches in a network fabric, the more possible paths that are calculated by the path controller. As used herein, a layer refers to the hierarchal relationship between connected switches in a network fabric. Data may travel from one switch to another and move up in layer or hierarchy before moving down to another switch in the same layer. As a non-limiting example, if data needs to travel from a source GPU to a destination GPU, which sit on the same layer, data from the source GPU must travel to a switch which sits at least one layer above the GPU layer before proceeding to the destination GPU layer. Multiple layers may be used without departing from the scope of the disclosure.

In step 204, the path controller creates a session for each path in the plurality of paths calculated in step 202. The sessions are created such that there is a one-to-one mapping between session and path. Said another way, if there are 20 calculated paths, the path controller will initiate 20 sessions. Each session will allow for data to be transferred and will further allow the scheduler to control the data flow through the session.

In step 206, the path controller associates each session to a source port of the port pair. In step 208, the path controller then associates each path of the plurality of paths with one of the sessions. As a non-limiting example, if there are 8 sessions associated with 8 paths starting at port 1, the path controller will associate those 8 sessions to port 1. This will allow for other components, including the path controller, to later generate a header with the correct starting source port.

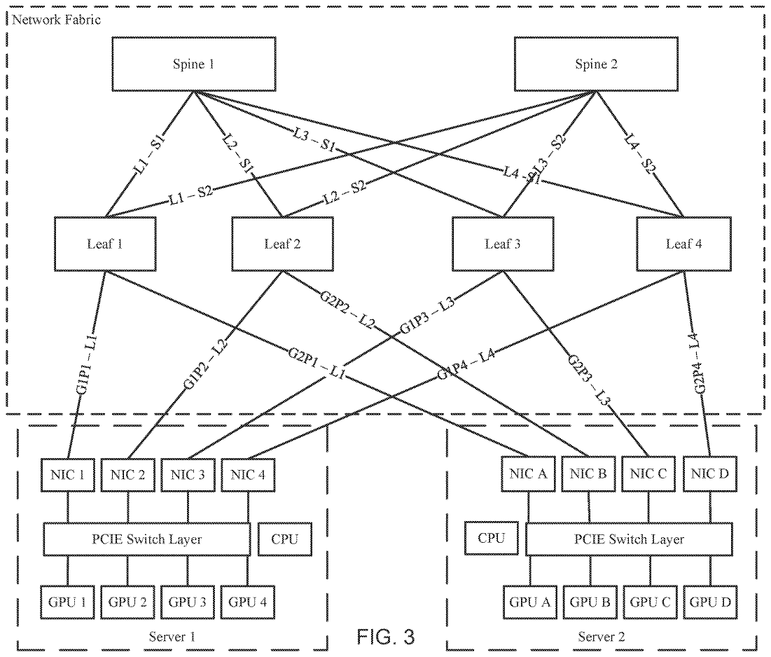

In step 210, the path controller generates session headers for each of the sessions. In one or more embodiments, the session headers may include the full segment list that the data traverses to travel between port pairs. A detailed example is given in the example associated with FIG. 3 below. In one or more embodiments, the session headers captures ordered headers with a denoted source and destination for each segment in the path. As a non-limiting example, if one path consists of 3 segments, the source port to a switch in the network fabric, and the switch to the destination port, the session header would contain a header 1 and header 2 that identify the sequential source and destination for each segment. In this manner, congestion can be identified at a per segment basis and provide additional granularity to better optimize the data transfer.

In step 212, the path controller makes a determination as to whether there are additional port pairs to transmit data across. In one or more embodiments, the determination is YES, and the method proceeds to step 200. In one or more embodiments, the determination is NO, and the method proceeds to FIG. 2.2.

Turning to FIG. 2.2, FIG. 2.2 shows a flowchart of a method for assigning session headers to paths in accordance with one or more embodiments of the disclosure. The method may be performed by, for example, the path controller (FIG. 1.1, 112A). Other components in the system may perform this method without departing form the scope of this disclosure.

While the various steps in the flowchart shown in FIG. 2.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2.2 may be performed concurrently with one or more steps in FIG. 2.1 and FIG. 2.3.

In step 220, the path controller assigns the session headers generated in step 210 to the paths associated with the source GPU port in the session header to obtain a plurality of unique paths. In one or more embodiments, each unique path associated with a port-pair may have the same starting and ending header with differing middle headers in the overall session header.

In step 222, the path controller assigns the plurality of unique paths to the NIC associated with the source GPU. While the source GPU may contain multiple source ports, each source port feeds into the NIC which then transmits the data through the network fabric. As a non-limiting example, if there are 8 unique paths from the ports associated with source GPU 1, each path will feed through NIC 1 before proceeding through the network fabric to a destination GPU.

In one or more embodiments, the method ends following step 222.

Turning to FIG. 2.3, FIG. 2.3 shows a flowchart of a method for transferring a workload between servers in accordance with one or more embodiments of the disclosure. The method may be performed by, for example, a scheduler (e.g., FIG. 1.1, Scheduler A (110A)). Further, the flowchart depicts steps for each workload associated with an application in a server (e.g., FIG. 1.1, Application A (114A)). Other components in the system may perform this method without departing from the scope of the disclosure herein.

While the various steps in the flowchart shown in FIG. 2.3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2.3 may be performed concurrently with one or more steps in FIG. 2.1 and FIG. 2.2.

In step 230, the scheduler receives a workload for a target GPU. In one or more embodiments, the workload is associated with an application in the server (e.g., FIG. 1.1, Server A (106A)) and the target GPU is in a different server from the server associated with the application. Further, in one or more embodiments, the two servers are connected over a network fabric (e.g., FIG. 1.1, 102). While this method depicts a workload spanning two servers, any number of servers can be incorporated in this method without departing from the scope of the disclosure herein.

In step 232, the scheduler obtains current latency information for all the paths between a source GPU and the target GPU to identify all available sessions. As used herein, an available session is defined as sessions with sufficiently clear memory and open path to facilitate data transfer without any slowdown in the expected data transfer rate. The expected data transfer rate is defined as the maximum data transfer speed between two ports. Further, the current latency information is defined as the information received by the NIC based on congestion and slowdown within the network fabric. This congestion and slowdown may be represented by queue draining rates calculated by the NIC and congestion information sent back to the server by switches in the network fabric. More information regarding switches transmitting congestion information is discussed in FIG. 2.4 below. In one or more embodiments, the switch is able to identify and relay congestion information faster than the NIC can identify and calculate queue draining rates.

In step 234, based on the current latency information, the scheduler allocates a portion of the workload to the available sessions associated with the source GPU. The portion may be any amount of the total workload, as determined by the scheduler. As a non-limiting example, the scheduler may portion the workload into 10 portions. Any number of portions may be created without departing from the scope of the disclosure. Further, in one or more embodiments, the portioning allows the scheduler to load balance and, therefore, optimize the data transfer based on the continuously updating current latency information.

In step 236, the scheduler initiates the transfer of the portion of the workload. In one or more embodiments, initiating refers to instructing the NIC associated with the source GPU to transmit the portion of the workload. In step 238, the scheduler makes a determination as to whether or not there are more portions to transfer. In one or more embodiments, the determination is YES, and the method proceeds to step 232. In one or more embodiments, the determination is NO, and the method ends.

Turning now to FIG. 2.4, FIG. 2.4 shows a flowchart of a method for notifying a source server about congestion along a path in accordance with one or more embodiments of the disclosure. The method may be performed by, for example, a switch in the network fabric. Other components in the system may perform this method without departing from the scope of this disclosure.

While the various steps in the flowchart shown in FIG. 2.4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2.4 may be performed concurrently with one or more steps in FIG. 2.1-2.3.

In step 240, each switch in the network fabric determines congestion along the path by monitoring and identifying a reduction in data transfer speeds associated with the workload sent through the switch. As a non-limiting example, if a switch receives data associated with the workload at 10 megabytes per second and transmits the data to the next layer in the network fabric at 5 megabytes per second, the switch may determine that there is congestion due to the 5 megabyte disparity between receiving and transmitting speeds.

In step 242, based on the determination, in one or more embodiments, the switch may modify the session header associated with the workload sent through the switch to generate a modified session header. In one or more embodiments, the modification may be switching the order of the segment list within the session header. More specifically, the switch may reverse the order of the segment list in the session header such that the source header within the segment list now reads as the destination header. In this manner, the modified session header will now point to the source header (e.g., server A (FIG. 1.1, 106A)) and any data transferred using this modified session header will arrive at the server or GPU associated with the source header.

In step 244, the switch, in one or more embodiments, may generate a payload containing updated network fabric information such as congestion information related to the congestion determined in step 240. The payload may also contain the modified session header. Other information beyond the congestion information may be included in the payload without departing from the scope of the disclosure.

In step 246, the switch, in one or more embodiments, may send the payload back to the source (e.g., source GPU, NIC, server, etc.) using the modified session header. In one or more embodiments, the payload follows the path set by the modified session header. More specifically, the payload follows the segment list contained within the modified session header.

In step 248, the switch continuously checks for more congestion along the path. In one or more embodiments, the method ends at step 248.

Turning now to FIG. 3, FIG. 3 shows an example network fabric in accordance with one or more embodiments of the disclosure. FIG. 3 will be discussed further in the example below.

### EXAMPLE

The following section describes an example depicted in FIG. 3 showing various embodiments of the invention. The example is for illustrative purposes only is not intended to limit the scope of invention. Turning to the example, consider a scenario in which one server (i.e., Server 1) receives a workload to transfer to another server (i.e., Server 2). Server 1 and Server 2 are connected over a network fabric and each server includes multiple GPUs, namely, Server 1 includes GPU 1, GPU 2, GPU 3, and GPU 4 while Server 2 includes GPU A, GPU B, GPU C, and GPU D. Each of the GPUs (i.e., GPU 1, GPU 2, GPU 3, GPU 4, GPU A, GPU B, GPU C, and GPU D) connect to unique network interface cards (NICs) (e.g., NIC 1, NIC 2, NIC 3, NIC 4, NIC A, NIC B, NIC C, NIC D) through a PCIE switch layer. The NICs connect to the network fabric. The NICs on Server 1 (e.g., NIC 1, NIC 2, NIC 3, and NIC 4) connect to the NICS on Server 2 (e.g., NIC A, NIC B, NIC C, and NIC D) over the network fabric in such a manner as to create multiple pathways for data to travel between both servers using their respective GPUs.

In the scenario, Server 1, via a path controller (not shown), initially determines all possible paths in the network fabric between Server 1 to Server 2. Server 1 then initiates a session for each of the identified paths and assigns the sessions to the source port starting the path. In the example, there are at least 28 paths between Server 1 and Server 2. Server 1 will accordingly initiate 28 sessions. Each GPU in Server 1 is the starting point for at least seven of the 28 paths. Thus, each GPU in Server 1 will be associated with at least seven sessions. Consider NIC 1. NIC 1 has at least seven paths from Server 1 through NIC 1 to any NIC in Server 2. Accordingly, Server 1 assigns the seven sessions associated with those seven paths to GPU 1 which is associated with NIC 1, where each path within the seven sessions has a starting point at GPU 1 but a different path leading to Server 2.

Continuing the example, the path controller then builds headers for each of the 28 sessions associated with the 28 paths. The headers, incorporated using a segment routing header (SRv6) into an IPv6 version of a ROCEv2 header, list each segment list as a start and end point sequentially through a user datagram protocol (UDP) header. Said another way, the SRv6 header includes a UDP header. For session 1, associated with path 1, the UDP header comprises two segment lists (G1P1-L1) and (G2P1-L1). The two segment lists relate two source and destination locations. This header generation continues for each of the 28 sessions.

After the assignment of sessions and incorporation of the headers, Server 1 receives a workload requiring the data transfer of 100 gigabytes to Server 2. The scheduler in Server 1 (not shown) portions the 100 gigabytes into a set of data portions. Each data portion contains 10 gigabytes. After portioning, the scheduler receives updated network fabric information and looks at the memory to identify which sessions have normal queue draining rates. The memory serves as a queue and feeds data to the session associated with the memory. The updated network fabric information comes from the switches in the network fabric (e.g., Leaf 1, Leaf 2, Leaf 3, Leaf 4, Spine 1, and Spine 2) which, when identifying congestion at the switch, reverse the UDP header information to send a payload back to the source port, here, the NICs, to inform the NIC of the congestion. The payload containing the updated network fabric information provides congestion information sooner than the memory updates to identify queue draining rates. Based on the updated network fabric information and the queue draining rates associated with memory in each session, Server 1 determines that Spine 1 and Spine 2 are congested. Any path that uses the spines will experience slow queue draining and the memory associated with those sessions will still be full. Accordingly, the only paths available are:
Path 1: (G1P1-L1)-(G2P1-L1);
Path 2: (G1P2-L2)-(G2P2-L2);
Path 3: (G1P3-L3)-(G2P3-L3); and
Path 4: (G1P4-L4)-(G2P4-L4).

These available paths are associated with sessions in NIC 1, NIC 2, NIC 3, and NIC 4. After identifying free sessions based on normal queue draining rates and the updated network fabric information provided by the switches, Server 1 distributes the first data portion in the set of data portions into the session memory of each free session such that each session contains 2.5 gigabytes of data.

After Server 1 identifies that a memory within any session is empty, the scheduler prepares the second data portion in the set of data portions to send to Server 2. The scheduler receives the updated network fabric information via payloads from Spine 1, Spine 2, and Leaf 1 to indicate network congestion even though the queue draining rates of all sessions associated with those switches currently appears to be within an expected range. Spine 1, Spine 2, and Leaf 1 proactively inform the scheduler of the network congestion by reversing the UDP headers and sending a payload back down the path to the source port. In this manner, the scheduler is able to load balance the next portion of the workload before the queue draining rates identified by the NIC can reflect the congestion. The free paths are Path 2, Path 3, and Path 4. Accordingly, the scheduler distributes the second data portion to the sessions associated with Paths 2-4 to avoid further congesting Leaf 1, Spine 1, and Spine 2. Of the 10 gigabytes in the second data portion, 4 gigabytes are allocated to the session associated with Path 2, 4 gigabytes are allocated to the session associated with Path 3, and 2 gigabytes are allocated to the session associated with Path 4 to offset the data still in the memory in the last session.

After identifying another empty memory, the scheduler prepares the third data portion in the set of data portions to send to Server 2. After receiving updated network fabric information from the switches and identifying the queue draining rates across the sessions, the scheduler determines that Leaf 1, Leaf 2, and Spine 1 are congested. Accordingly, the paths available are:
Path 3: (G1P3-L3)-(G2P3-L3);
Path 4: (G1P4-L4)-(G2P4-L4);
Path 5: (G1P3-L3)-(L3-S2)-(L4-S2)-(G2P4-L4);
Path 6: (G1P4-L4)-(L4-S2)-(L3-S2)-(G2P3-L3);

The scheduler evenly distributes the third data portion to sessions associated with paths 3-6 to avoid further congesting Leaf 1, Leaf 2, and Spine 1.

This process continues until all portions of the workload are transferred. After completing the data transfer via transferring all portions of the workload, the example ends.

### End of Example

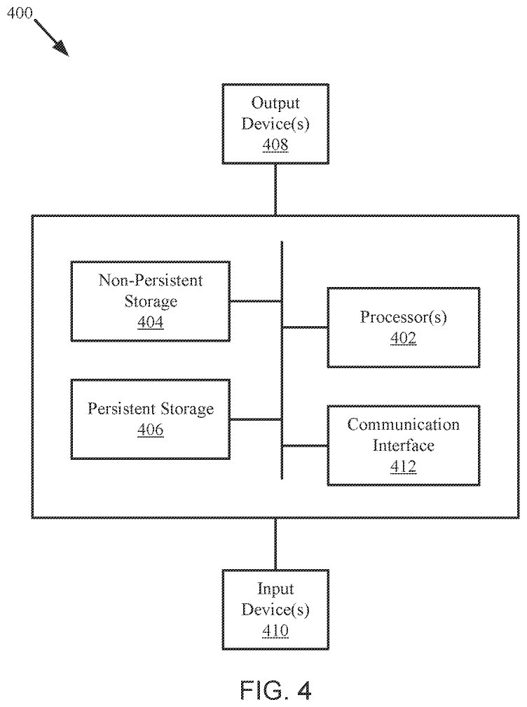

Embodiments of the disclosure may be implemented using computing devices. Turning to FIG. 4, FIG. 4 shows a diagram of a computing device (400) in accordance with one or more embodiments. The computing device (400) may include one or more computer processor(s) (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), input devices (410), output devices (412), and numerous other elements (not shown) and functionalities. Each of these components is described below.

In one embodiment, the computer processor(s) (402) may be an integrated circuit for processing instructions. For example, the computer processor(s) (402) may be one or more cores or micro-cores of a processor. The computing device (400) may also include one or more input devices (410), such as a touchscreen, access keyboard, mouse, microphone, touchpad, electronic pen, or any other type of input device. The communication interface (408) may include an integrated circuit for connecting the computing device (400) to a network such as the Internet, mobile network, or any other type of network) and/or to another device, such as another computing device.

In one embodiment, the computing device (400) may include one or more output devices (412), such as a screen (e.g., a liquid crystal display (LCD), a plasma display, touchscreen, cathode ray tube (CRT) monitor, projector, or other display device), a printer, external storage, or any other output device. One or more of the output devices (412) may be the same or different from the input devices (410). The input and output device(s) (410, 412) may be locally or remotely connected to the computer processor(s) (402), non-persistent storage (404), and persistent storage (406). Many diverse types of computing devices exist, and the aforementioned input and output device(s) (410, 412) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connection between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage module, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for managing data transfer workloads, the method comprising:
distributing a first portion of a workload across a plurality of sessions, wherein a session within the plurality of sessions comprises a session header;
making, after the distributing, a first determination that a path within the plurality of sessions is experiencing congestion, wherein congestion is identified by parsing a payload sent by a switch in a network fabric;
redistributing, after the first determination, a second portion of the workload to the plurality of sessions to optimize the data transfer speed across the plurality of sessions;
making a second determination, after redistributing, that the workload has not been fully transferred;
making a third determination, after the second determination, that a second path within the plurality of sessions is experiencing second congestion;
redistributing, based on the second determination and the third determination, a third portion of the workload to the plurality of sessions.

2. The method of claim 1, wherein the workload comprises sending data from a source Graphics Processing Unit (GPU) to a destination GPU.

3. The method of claim 1, wherein the modified session header comprises path information, wherein the path information describes a path over a network fabric between the source GPU and the destination GPU, and the session header comprises a source header associated with the source GPU and a destination header associated with the destination GPU.

4. The method of claim 1, further comprising:
prior to the distributing, calculating a plurality of paths between the source GPU and the destination GPU, wherein each path within the plurality of paths corresponds to a segment list;
recording, after calculating, each path within the plurality of paths into a plurality of session headers; and
initiating, after recording, a plurality of sessions, wherein each session within the plurality of sessions corresponds to a path within the plurality of paths and wherein each session is associated with a GPU port within the source GPU.

5. The method of claim 4, wherein the plurality of paths comprises all possible paths the data can take in the network fabric between the source GPU and the destination GPU.

6. The method of claim 5, wherein the network fabric comprises a plurality of switches.

7. The method of claim 6, wherein the plurality of switches comprises a leaf switch and a spine switch and the switch.

8. The method of claim 1, wherein the congestion comprises a bottleneck along a segment of the path in the network fabric, and wherein the payload sent by the switch further comprises a modified session header generated by reversing the segment list in the session header to ensure the payload arrives at the source GPU.

9. A non-transitory computer readable medium comprising computer readable program code, which when executed by a computer processor enables the computer processor to perform a method for managing data transfer workloads, the method comprising:
distributing a first portion of a workload across a plurality of sessions, wherein a session within the plurality of sessions comprises a session header;
making, after the distributing, a first determination that a path within the plurality of sessions is experiencing congestion, wherein congestion is identified by parsing a payload sent by a switch in a network fabric;
redistributing, after the first determination, a second portion of the workload to the plurality of sessions to optimize the data transfer speed across the plurality of sessions;
making a second determination, after redistributing, that the workload has not been fully transferred;
making a third determination, after the second determination, that a second path within the plurality of sessions is experiencing second congestion;
redistributing, based on the second determination and the third determination, a third portion of the workload to the plurality of sessions.

10. The non-transitory computer readable medium of claim 9, wherein the workload comprises sending data from a source Graphics Processing Unit (GPU) to a destination GPU.

11. The non-transitory computer readable medium of claim 9, wherein the modified session header comprises path information, wherein the path information describes a path over a network fabric between the source GPU and the destination GPU, and the session header comprises a source header associated with the source GPU and a destination header associated with the destination GPU.

12. The non-transitory computer readable medium of claim 9, further comprising:
prior to the distributing, calculating a plurality of paths between the source GPU and the destination GPU, wherein each path within the plurality of paths corresponds to a segment list;
recording, after calculating, each path within the plurality of paths into a plurality of session headers; and
initiating, after recording, a plurality of sessions, wherein each session within the plurality of sessions corresponds to a path within the plurality of paths and wherein each session is associated with a GPU port within the source GPU.

13. The non-transitory computer readable medium of claim 12, wherein the plurality of paths comprises all possible paths the data can take between the source GPU and the destination GPU.

14. The non-transitory computer readable medium of claim 13, wherein the data travels between the source GPU and the destination GPU through a network fabric comprising a series of switches.

15. The non-transitory computer readable medium of claim 14, wherein the plurality of switches comprises a leaf switch and a spine switch and the switch.

16. The non-transitory computer readable medium of claim 9, wherein the congestion comprises a bottleneck along a segment of the path in the network fabric, and wherein the payload sent by the switch further comprises a modified session header generated by reversing the segment list in the session header to ensure the payload arrives at the source GPU.

17. A system for managing data transfer workloads, the system comprising:
a processor; and
storage comprising instructions, which when executed by the processor perform a method, the method comprising:
distributing a first portion of a workload across a plurality of sessions, wherein a session within the plurality of sessions comprises a session header;
making, after the distributing, a first determination that a path within the plurality of sessions is experiencing congestion, wherein congestion is identified by parsing a payload sent by a switch in a network fabric;
redistributing, after the first determination, a second portion of the workload to the plurality of sessions to optimize the data transfer speed across the plurality of sessions;
making a second determination, after redistributing, that the workload has not been fully transferred;
making a third determination, after the second determination, that a second path within the plurality of sessions is experiencing second congestion;
redistributing, based on the second determination and the third determination, a third portion of the workload to the plurality of sessions.

18. The system of claim 17, wherein the workload comprises sending data from a source Graphics Processing Unit (GPU) to a destination GPU.

19. The system of claim 17, wherein the modified session header comprises path information, wherein the path information describes a path over a network fabric between the source GPU and the destination GPU, and the session header comprises a source header associated with the source GPU and a destination header associated with the destination GPU.

20. The system of claim 17, further comprising:
prior to the distributing, calculating a plurality of paths between the source GPU and the destination GPU, wherein each path within the plurality of paths corresponds to a segment list;
recording, after calculating, each path within the plurality of paths into a plurality of session headers; and
initiating, after recording, a plurality of sessions, wherein each session within the plurality of sessions corresponds to a path within the plurality of paths and wherein each session is associated with a GPU port within the source GPU.
